(19) United States
(12) Patent Application Publication
(10) Pub. No.: US 2008/0113222 A1
(43) Pub. Date: May 15, 2008

(54) THIN FILM MAGNETIC HEAD FOR DETECTING LEAK MAGNETIC FIELD FROM RECORDING MEDIUM BY USING TUNNEL MAGNETORESISTIVE EFFECT

(76) Inventors: Atsushi Tondokoro, Niigata-ken (JP); Takahisa Takahashi, Niigata-ken (JP)

Correspondence Address: BRINKS HOFER GILSON & LIONE, P.O. BOX 10395, CHICAGO, IL, 60610, US

(21) Appl. No.: 11/928,597

(22) Filed: Oct. 30, 2007

(30) Foreign Application Priority Data
Nov. 10, 2006 (JP) 2006-304664

(51) Int. Cl. G11B 5/33

(52) U.S. Cl. 428/812

(57) ABSTRACT

A thin film magnetic head includes: an element part formed by laminating an antiferromagnetic layer, a fixed magnetic layer, an insulating barrier layer, and a free magnetic layer on a substrate; and a protective layer that protects an end surface of the element part opposite a recording medium. The insulating barrier layer is formed using an AlOx film or an MgO film. An adhesive layer is provided between the protective layer and the end surface of the element part on which the insulating barrier layer is exposed, a nitride existing on at least an interface between the adhesive layer and the insulating barrier layer

### RELATED APPLICATIONS

This application claims the benefit of Japanese Patent Application No. 2006-304664 filed Nov. 10, 2006, which is hereby incorporated by reference.

### BACKGROUND

1. Field of the Invention

The present invention relates to a thin film magnetic head for detecting a leak magnetic field from a recording medium by using a tunnel magnetoresistive effect.

2. Description of the Related Art

In recent years, a thin film magnetic head (TMR head) using a tunnel magnetoresistive effect has been drawing attention as a head for reproduction that replaces a thin film magnetic head (GMR head) using a giant magnetoresistive effect. The TMR head includes: an element part obtained by laminating an antiferromagnetic layer, a fixed magnetic layer whose magnetization direction is fixed by an exchange coupling magnetic field between the fixed magnetic layer and the antiferromagnetic layer, an insulating barrier layer, and a free magnetic layer on an Al2O3-TiC substrate; a lower electrode layer and an upper electrode layer disposed opposite to each other with the element part interposed there

between in the lamination direction; a vertical bias layer that is located at both sides of the element part to apply a vertical bias magnetic field to the free magnetic layer; and a protective layer that covers an end surface of the element part opposite a recording medium.

In the TMR head, when a voltage is applied to the fixed magnetic layer and the free magnetic layer, a current (tunnel current) flows through the insulating barrier layer due to a tunnel effect. When there is no external magnetic field, the free magnetic layer is magnetized in the direction of 90° with respect to the fixed magnetization direction of the fixed magnetic layer due to the vertical bias layer. However, when an external magnetic field is applied, the magnetization direction of the free magnetic layer is changed due to the influence of the external magnetic field. A resistance value of the element part becomes a maximum when the magnetization direction of the fixed magnetic layer is antiparallel to the magnetization direction of the free magnetic layer and becomes a minimum when the magnetization direction of the fixed magnetic layer is parallel to the magnetization direction of the free magnetic layer. The TMR head reads a leak magnetic field (magnetic record information) from a recording medium through a change in resistance value of the element part. A resistance change rate (TMR ratio) of the TMR head is several tens of percent. Accordingly, it is possible to obtain a very large reproduction output in the TMR head, as compared with a GMR head whose resistance change rate is several percent or ten and several percent.

In a known TMR head, generally, the fixed magnetic layer and the free magnetic layer are formed of a ferromagnetic material, such as NiFe and FeCo, the insulating barrier layer is formed of an insulating material, such as Al₂O₃, and the protective layer is formed using a DLC film. In addition, it is practical to provide an adhesive layer between the DLC protective layer and an end surface of the element part covered by the DLC protective layer in order to improve adhesion of the protective layer. Si is used for the adhesive layer.

In recent years, it has been proposed to form the insulating barrier layer using AlOx or MgO in order to obtain a high magnetoresistance ratio corresponding to the higher recording density. However, in the case when the insulating barrier layer is formed of AlOx or MgO, a leakage current is generated on an interface between an adhesive layer formed of Si and the insulating barrier layer formed of AlOx or MgO. As a result, since the leakage current serves as a noise (popcorn noise) of an element output, a noise characteristic deteriorates.

### SUMMARY

According to a study of the inventor, the following three reasons may be mentioned as a cause of generation of a leakage current on an interface between an insulating barrier layer and an adhesive layer. First, an outermost surface of the insulating barrier layer is lost due to IBE (ion beaming etching) or wrapping processing, and accordingly, oxygen existing within the insulating barrier layer is escaped to the outside through the lost portion. As a result, a state of the outermost surface of the insulating barrier layer is changed to a state deficient in oxygen. Second, oxygen of the insulating barrier layer is absorbed in the adhesive layer. As a result, the state of the outermost surface of the insulating barrier layer is changed to a state deficient in oxygen. Third, an Al atom or an Mg atom in the insulating barrier layer and an Si atom in the adhesive layer are bound on an interface between the insulating barrier layer and the adhesive layer, and accordingly, AlSi or MgSi is generated. Since AlSi and MgSi are conductive compounds, a leakage current is generated due to the AlSi and the MgSi. For example, JP-A-2005-108355 discloses that O atoms remain in an insulating barrier layer due to an oxide layer provided on an outermost surface of the insulating barrier layer. However, if the insulating barrier layer is subjected to an oxidation treatment, a spacing loss (dead layer) occurs due to expansion of the adhesive layer caused by the oxidation or formation of an oxidized layer caused by introduction of high-energy O2. As a result, a dynamic electrical property (DET property) deteriorates. For this reason, the technique disclosed in JP-A-2005-108355 is not preferable. The invention has been finalized by finding out that a binding state of an Al atom and an O atom or a binding state of an Mg atom and an O atom in an insulating barrier layer formed using an AlOx film or an MgO film is stabilized by a nitriding treatment, and as a result, O atoms remain in the insulating barrier layer, AlSi or MgSi is not generated on an interface between the insulating barrier layer and an adhesive layer, and an improvement is made in terms of the spacing loss compared with the oxidation treatment.

That is, according to an aspect of the disclosure, there is provided a thin film magnetic head including: an element part formed by laminating an antiferromagnetic layer, a fixed magnetic layer, an insulating barrier layer, and a free magnetic layer on a substrate; and a protective layer that protects an end surface of the element part opposite a recording medium. The insulating barrier layer is formed using an AlOx film or an MgO film. An adhesive layer is provided between the protective layer and the end surface of the element part on which the insulating barrier layer is exposed, a nitride existing on at least an interface between the adhesive layer and the insulating barrier layer.

Specifically, it is preferable that the end surface of the element part be a nitrided surface subjected to a nitriding treatment and the adhesive layer made of Si be formed on the nitrided surface. Further, it is preferable that the adhesive layer is formed on the end surface of the element part so as to have a single layered structure including an Si-based nitride layer.

According to the invention, even if an insulating barrier layer is formed using an AlOx film or an MgO film, a leakage current from the insulating barrier layer is not generated, and thus a thin film magnetic head having a satisfactory noise characteristic is obtained.

### BRIEF DESCRIPTION OF THE DRAWINGS

FIG. 1 is a cross-sectional view illustrating the structure of a thin film magnetic head according to a first embodiment of the disclosure as viewed from a surface side thereof opposite a recording medium;

FIG. 2 is a cross-sectional view illustrating the structure of the thin film magnetic head cut in the middle of an element;

FIG. 3 is an enlarged sectional view schematically illustrating a front end surface of a tunnel type magnetoresistive effect element and an adhesive layer provided in the thin film magnetic head shown in FIG. 1;

FIG. 4 is an enlarged sectional view schematically illustrating a front end surface of a tunnel type magnetoresistive effect element and an adhesive layer provided in a thin film magnetic head according to a second embodiment of the disclosure; and

FIG. 5 is an enlarged sectional view schematically illustrating a front end surface of a tunnel type magnetoresistive effect element and an adhesive layer provided in a thin film magnetic head according to a third embodiment of the disclosure.

### DESCRIPTION OF THE EMBODIMENTS

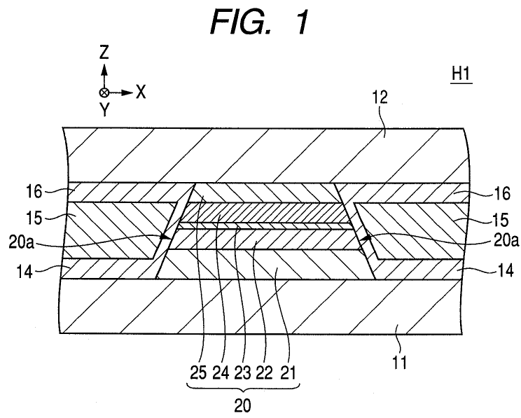

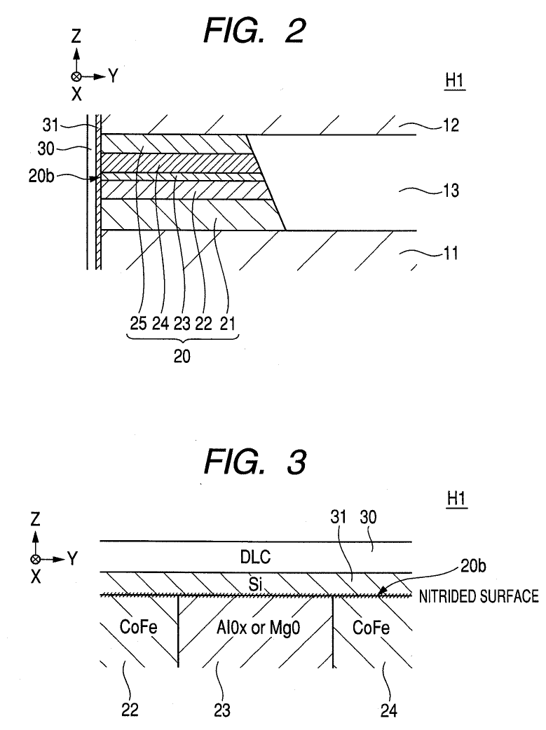

FIG. 1 is a cross-sectional view illustrating the structure of a thin film magnetic head H1 according to a first embodiment of the disclosure as viewed from a surface side thereof opposite a recording medium. FIG. 2 is a longitudinal sectional view illustrating the structure of the thin film magnetic head H1 cut in the middle of an element. In the drawings, X, Y, and Z directions indicate a track width direction, a height direction, and a direction in which layers that form a magnetoresistive effect element are laminated, respectively.

The thin film magnetic head H1 is a tunnel effect type thin film magnetic head for reproduction (hereinafter, referred to as a ‘TMR head’) which detects a leak magnetic field from a recording medium using a tunnel effect. The thin film magnetic head H1 includes an element part (tunnel type magnetoresistive effect element) 20 provided between a lower electrode layer 11 and an upper electrode layer 12, the element part 20 having an antiferromagnetic layer 21, a fixed magnetic layer 22, an insulating barrier layer 23, a free magnetic layer 24, and a conductive layer 25 laminated sequentially from the lower electrode layer side.

Both side surfaces 20a of the element part 20 are formed as inclined surfaces such that the width between the side surfaces 20a increases toward the lower electrode layer 11 side, as shown in FIG. 1. On a rear side of the element part 20 in the height direction (rear side in the Y direction shown in the drawing), an insulating layer 13 formed of, for example, Al₂O₃ or SiO₂ is provided as shown in FIG. 2.

The lower electrode layer 11 and the upper electrode layer 12 are formed of a conductive material, such as Cu, W, and Cr. The lower electrode layer 11 and the upper electrode layer 12 are formed to extend longer than the element part 20 in both directions of the track width direction (X direction shown in the drawing) and the height direction (Y direction shown in the drawing).

It is preferable that the antiferromagnetic layer 21 be formed of an X—Mn based alloy (where an element X is any one or two or more elements selected from Pt, Pd, Ir, Rh, Ru, and Os) or an X—Mn—X′ alloy (where an element X′ is any one or two or more elements selected from Ne, Ar, Kr, Xe, Be, B, C, N, Mg, Al, Si, Pt, V, Cr, Fe, Co, Ni, Cu, Zn, Ga, Ge, Zr, Nb, Mo, Ag, Cd, Sn, Hf, Xa, W, Re, Au, Pb, and rare earth elements. Each of these alloys has an irregular face-centered cubic (i) structure in a state immediately after film formation. However, the structure of each of the alloys may be changed to a regular face-centered tetragonal (fct) structure by a heat treatment, such that a large exchange coupling magnetic field can be generated between each of the alloys and the fixed magnetic layers 22. In the present embodiment, the antiferromagnetic layer 21 is formed of a PtMn alloy and causes a large exchange coupling magnetic field exceeding 64 kA/m to be generated between the antiferromagnetic layer 21 and the fixed magnetic layers 22. That is, the antiferromagnetic layer 21 has an excellent antiferromagnetic property in which the blocking temperature, at which the exchange coupling magnetic field is lost, is 380° which is very high.

The fixed magnetic layer 22 is formed using a CoFe alloy film, and the magnetization direction of the fixed magnetic layer 22 is fixed in the height direction (Y direction shown in the drawing) by the exchange coupling magnetic field generated between the fixed magnetic layer 22 and the antiferromagnetic layer 21. The insulating barrier layer 23 is formed of an AlOx film or an MgO film in a small thickness of about 0.5 nm. The free magnetic layer 24 is formed of a CoFe alloy film and is magnetized in the track width direction (X direction shown in the drawing) by a bias magnetic field from the bias layer 15. The free magnetic layer 24 is magnetized in the direction of 90° with respect to the magnetization direction of the fixed magnetic layer 22 in a state where there is no external magnetic field. However, when an external magnetic field is applied from the height direction (Y direction shown in the drawing), the magnetization direction of the free magnetic layer 24 is changed due to the influence of the external magnetic field. The fixed magnetic layer 22 and the free magnetic layer 24 may be formed of an NiFe alloy film, a Co film, a CoNiFe alloy film, and the like. The conductive layer 25 is formed of a conductive material, such as Ta, and serves as an electrode together with the upper electrode layer 12.

Furthermore, a first insulating layer 14, a bias layer 15, and a second insulating layer 16 are formed between the lower electrode layer 11 and the upper electrode layer 12 so as to be laminated sequentially from the lower electrode layer 11 side and be positioned on both sides of the element part 20. The bias layer 15 is provided adjacent to both side surfaces of the element part 20 and applies a bias magnetic field to the free magnetic layer 24 such that the free magnetic layer 24 is magnetized in the track width direction (X direction shown in the drawing), as described above. The bias layer 15 is formed of a hard magnetic material, such as a Co—Pt alloy film and a Co—Cr—Pt alloy film. Although not shown, a bias underlayer is formed immediately below the bias layer 15. The first insulating layer 14 and the second insulating layer 16 are formed of an insulating material, such as Al₂O₃ or SiO₂, and electrically insulate the lower electrode layer 11 and the upper electrode layers 12 from each other.

When a sense current is made to flow in the lamination direction of the element part 20 through the lower electrode layer 11 and the upper electrode layer 12, the intensity of a tunnel current passing through the element part 20 is changed according to the relationship between magnetization directions of the fixed magnetic layer 22 and the free magnetic layer 24. For example, when the magnetization direction of the fixed magnetic layer 22 is parallel to the magnetization direction of the free magnetic layer 24, conductance G (reciprocal of resistance) becomes a maximum, and accordingly, a tunnel current also becomes a maximum. In contrast, the magnetization direction of the fixed magnetic layer 22 is antiparallel to the magnetization direction of the free magnetic layer 24, the conductance G becomes a minimum, and accordingly, the tunnel current also becomes a minimum. The thin film magnetic head H1 regards a change in the amount of a tunnel current flowing through the element part 20 as an electric resistance change and converts the electric resistance change into a voltage change, thereby detecting a leak magnetic field from a recording medium.

On an end surface of the thin film magnetic head H1 facing a recording medium, a protective layer 30 that covers a front end surface 20b of the element part 20 (antiferromagnetic layer 21, fixed magnetic layer 22, insulating barrier layer 23, free magnetic layer 24, and conductive layer 25) in order to prevent the element part 20 from corroding or wearing and an adhesive layer 31 for improving adhesion of the protective layer 30 are formed facing the front surface 20b, as shown in FIG. 2. The protective layer 30 is formed using a DLC (diamond-like carbon) film.

In the invention, the adhesive layer provided between the front end surface 20b of the element part 20 and the protective layer 30 is includes. Now, the adhesive layer will be described in detail with reference to FIGS. 3 to 5.

FIG. 3 is an enlarged sectional view schematically illustrating the front end surface 20b of the element part 20 and the adhesive layer 31 provided in the thin film magnetic head H1 according to the first embodiment.

In the thin film magnetic head H1, the entire front end surface (end surface facing a recording medium) 20b of the element part 20 is subjected to a nitriding treatment to form a nitrided surface α, and the adhesive layer 31 formed of Si is laminated on the nitrided surface α. The nitrided surface α is easily formed by an N2 plasma treatment using high-frequency plasma, microwave plasma, or a reactive ion beam, for example. The adhesive layer 31 is formed thin using a sputtering method or a vacuum deposition method, for example.

A plurality of N atoms exist on the nitrided surface α. Since the N atoms cover a front end surface of the insulating barrier layer 23, a binding state of atoms (an Al atom and an O atom in the case of an insulating barrier layer formed of an AlOx film and an Mg atom and an O atom in the case of an insulating barrier layer formed of an MgO) that form the insulating barrier layer 23 is stabilized. Accordingly, since the reactivity of Al atoms or Mg atoms in the insulating barrier layer 23 is low, AlSi or MgSi is not easily generated on an interface between the adhesive layer 31 and the insulating barrier layer 23. In addition, O atoms of the insulating barrier layer 23 remain in the insulating barrier layer 23 without being absorbed in the adhesive layer 31 and escaping to the outside. As a result, an insulation property of the insulating barrier layer 23 is secured good, and a probability that a leakage current will be generated on the interface between the adhesive layer 31 and the insulating barrier layer 23 is low. That is, since a noise occurring due to the leakage current can be suppressed, it is possible to obtain a satisfactory output of the element part 20 not including a noise.

Although the entire front end surface 20b of the element part 20 is subjected to the nitriding treatment to form the nitrided surface α in the first embodiment, at least a front end surface of the insulating barrier layer 23 may be the nitrided surface α.

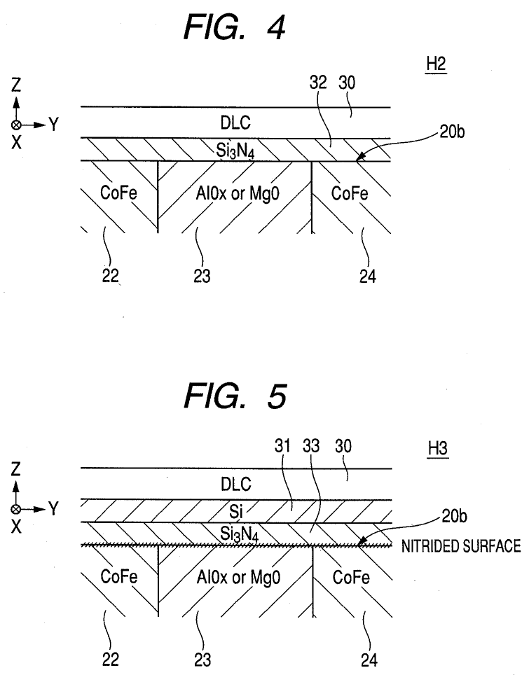

FIG. 4 is an enlarged sectional view schematically illustrating a front end surface 20b of an element part 20 and an adhesive layer 32 provided in a thin film magnetic head H2 according to a second embodiment.

The thin film magnetic heads H2 according to the second embodiment is different from the thin film magnetic head H1 according to the first embodiment in that the front end surface 20b of the element part 20 is not a nitrided surface and the adhesive layer 32 made of Si₃N₄ is provided between the front end surface 20b of the element part 20 and the protective layer 30. Even if the adhesive layer 32 is formed using an Si-based nitride layer, a binding state of an Al atom and an O atom in an AlOx film or a binding state of an Mg atom and an O atom in an MgO film that forms the insulating barrier layer 23 is stabilized due to N atoms in the adhesive layer 32. Accordingly, AlSi or MgSi is not easily generated on an interface between the adhesive layer 31 and the insulating barrier layer 23 and the O atoms of the insulating barrier layer 23 remain in the insulating barrier layer 23. As a result, since a leakage current on the interface between the adhesive layer 31 and the insulating barrier layer 23 is suppressed, a satisfactory noise characteristic is obtained. The adhesive layer 32 is formed thin using a sputtering method or a vacuum deposition method, for example. In addition, the adhesive layer 32 may be formed using an Si-based nitride, such as SiN and SiON, instead of Si₃N₄. The configuration of the thin film magnetic head H2 according to the second embodiment is the same as that of the thin film magnetic head H1 according to the first embodiment except for the adhesive layer 32 and the front end surface 20b of the element part 20. In FIG. 4, constituent components having the same functions as in the first embodiment are denoted by the same reference numerals.

In the second embodiment, the adhesive layer 32 made of Si₃N₄ is formed entirely between the front end surface 20b of the element part 20 and the protective layer 30, as shown in FIG. 4. However, the adhesive layer 32 may be formed on at least a front end surface of the insulating barrier layer 23.

FIG. 5 is an enlarged sectional view schematically illustrating a front end surface 20b of an element part 20 and an adhesive layer 33 provided in a thin film magnetic head H3 according to a third embodiment.

The thin film magnetic head H3 according to the third embodiment is different from the thin film magnetic head H1 according to the first embodiment in that the second adhesive layer 33 formed of Si₃N₄ is interposed between a nitrided surface a (front end surface 20b of the element part 20 which is subjected to a nitriding treatment) and an adhesive layer 31 (first adhesive layer 31). Since the second adhesive layer 33 is interposed, a binding state of an Al atom and an O atom or a binding state of an Mg atom and an O atom within the insulating barrier layer 23 is further stabilized. Accordingly, a probability that a leakage current will be generated becomes lower than that in the first and second embodiments described above. As a result, it is possible to obtain a thin film magnetic head excellent in a noise characteristic. The second adhesive layer 33 is formed thin using a sputtering method or a vacuum deposition method, for example. In addition, the second adhesive layer 33 may be formed using an Si-based nitride, such as SiN and SiON, instead of Si₃N₄. The configuration of the thin film magnetic head H3 according to the third embodiment is the same as that of the thin film magnetic head H1 according to the first embodiment except for the second adhesive layer 33. In FIG. 5, constituent components having the same functions as in the first embodiment are denoted by the same reference numerals.

Although the entire front end surface 20b of the element part 20 is subjected to the nitriding treatment to form the nitrided surface α in the third embodiment, at least a front end surface of the insulating barrier layer 23 may be the nitrided surface α and the entire front end surface 20b of the element part 20 does not necessarily need to be the nitrided surface α. Similarly, the second adhesive layer 33 made of Si₃N₄ may also be formed on at least a front end surface of the insulating barrier layer 23.

As described above, in the present embodiment, a binding state of an Al atom and an O atom in an AlOx film or a binding state of an Mg atom and an O atom in an MgO film that forms the insulating barrier layer 23 of the element part 20 is further stabilized due to N atoms existing on an interface between the front end surface 20b of the element part 20 and the adhesive layer. Accordingly, even if the insulating barrier layer 23 is formed using the AlOx film or the MgO film, a leakage current is not easily generated on the interface between the insulating barrier layer 23 and the adhesive layer 31 (32, 33). As a result, a thin film magnetic head excellent in a noise characteristic can be obtained.

Hereinbefore, the thin film magnetic head for reproduction having the tunnel type magnetoresistive effect element has been described. In addition, the invention may also be applied to a thin film magnetic head for recording having a tunnel type magnetoresistive effect element and an inductive head element.

1. A thin film magnetic head comprising:
an element part including a laminated substrate of an antiferromagnetic layer, a fixed magnetic layer, an insulating barrier layer, and a free magnetic layer; and
a protective layer that protects an end surface of the element part opposite a recording medium,
wherein the insulating barrier layer is formed using an AlOx film or an MgO film, and
an adhesive layer is provided between the protective layer and the end surface of the element part on which the insulating barrier layer is exposed, a nitride existing on at least an interface between the adhesive layer and the insulating barrier layer.

2. The thin film magnetic head according to claim 1,
wherein the end surface of the element part is a nitrided surface subjected to a nitriding treatment, and
the adhesive layer made of Si is formed on the nitrided surface.

3. The thin film magnetic head according to claim 1,
wherein the adhesive layer is comprises a single layered structure including an Si-based nitride layer.

4. The thin film magnetic head according to claim 1,
wherein the end surface of the element part is a nitrided surface subjected to a nitriding treatment, and
the adhesive layer is formed in a structure where an Si-based nitride layer and an Si layer are sequentially laminated on the nitrided surface.

5. The thin film magnetic head according to claim 3,
wherein the Si-based nitride layer is formed of Si₃N₄, SiN, or SiON.

6. The thin film magnetic head according to claim 1,
wherein the protective layer is formed using a diamond-like carbon film.
